(19) United States
(12) Patent Application Publication
(10) Pub. No.: US 2010/0274608 A1
(43) Pub. Date: Oct. 28, 2010

(54) METHOD FOR CREATING AND DELIVERING NEW CARRIER PRODUCTS

(76) Inventors: Leon A. Pintsov, West Hartford, CT (US); Andrei Obrea, Seymour, CT (US)

Correspondence Address: PITNEY BOWES INC.;INTELLECTUAL PROPERTY & TECH. LAW DEPT., 35 WATERVIEW DRIVE, MSC 26-22, SHELTON, CT, 06484, US

(21) Appl. No.: 12/747,581

(22) PCT Filed: Dec. 1, 2008
(86) PCT No.: PCT/US08/85197

§ 371 Date: Jun. 11, 2010

Related U.S. Application Data
(60) Provisional application No. 61/013,727, filed on Dec. 14, 2007.

(51) Int. Cl. G06F 17/50

(52) U.S. Cl. 705/7

(57) ABSTRACT

The invention creates new carrier products under control of a computer. This is achieved via formal representations of postal and carrier products. It should be understood that the term new product applies to both a completely new product containing an entirely new set of features as well as an update to an existing product with possibly only a few new features or modifications are added.

### FIELD OF THE INVENTION

This invention relates to mailing systems and more particularly to automating the creation and delivery of new postal products in a networked environment.

### BACKGROUND OF THE INVENTION

Governments have created postal services for collecting, sorting and distributing the mail. It is difficult for government and private postal services to define and supply new services to the public. The postal service produces and performs operations on a physical item called a mail unit and obtains detailed information about operations and supplying this information to end users i.e., senders and recipients. The postal service or post office communicates product features geared to humans not machines. Humans are inefficient to change, machines more readily accept changes.

Traditional postal product like first class and standard mail can be defined and explained in simple terms and therefore end users do not have problems creating mail for first class and standard mail services. With increased sophistication of postal products and associated requirements effective use of new postal products by mailers is hindered by the lack of automation.

Even if mailers understood the features of new and more sophisticated postal products creating mail units that would meet the access requirement by the products is increasingly difficult i.e, many new products also known as valuated services require presenting a unique identifier on the mail unit and an indication of the type of service being requested. Both of the aforementioned data elements would have to be properly formatted and positioned on the mail unit in order that the postal operator can accurately capture and interpret these data elements to deliver the requested service.

Modern postal networks and their internal operations are designed around traditional inflexible and rigid workflows and schedules. This impedes creation and implementation of services of postal products that demand dynamic changes in postal operations, i.e., changing the route or destination for a given mail unit when it becomes clear that it is nearly impossible to deliver the mail units on time to their original destinations.

Thus, one of the problems of the prior art is that the creation of new postal products which involves human operations which are notoriously prone to errors. An additional problem is that it takes extraordinary long time because there is no good process of collecting summarizing and formalizing user needs and requirements and when these requirements are collected it is very difficult to assess their feasibility in the context of what even carrier network, process and equipment can actually deliver. To that extent, formalizing network process and equipment capabilities for the purpose of automated comparison with user requirements is an unsolved problem.

### SUMMARY OF THE INVENTION

This invention overcomes the disadvantages of the prior art by automating the determination by computer of feasibility of new postal product to be deliverable within constraints of the carrier network. This is achieved via formal representations of postal and carrier products. It should be understood that the term new product applies to both a completely new product containing an entirely new set of features as well as an update to an existing product with possibly only a few new features or modifications are added. The expressions postal product and carrier product are used interchangeability.

The invention describes a formal mechanism for defining network, process and equipment constraints in the carrier network.

The mechanism for defining these constraints is used for determining consistency between such constraints and formalized data structures representing candidates for postal products. Once this consistency is established, the invention further defines necessary cost estimation procedures using aforementioned formalized description of constraints and products.

The foregoing may be accomplished by a) creating a formal language for describing carrier network, process and equipment constraints and capabilities, b) using said language creating databases containing network, process and equipment constraints, c) creating by computer a comparison between postal product requirements and carrier network, process and equipment capabilities and constraints, d) upon comparison determining feasibility of a given candidate postal product and modifications required for delivery of such product in terms of modifications to network, process and equipment, e) determining the cost of said modifications using cost-causative attributes of carrier network, process and equipment.

### BRIEF DESCRIPTION OF THE DRAWINGS

FIG. 1 is a system diagram of the mailer and carrier information infrastructure.

FIG. 2 is a system diagram of the carrier infrastructure.

FIG. 3 is the top level flowchart of the operational analysis process.

FIGS. 4A-4D is the flowchart of the process that compares the attributes of the candidate carrier product against the capabilities of the carrier infrastructure.

FIG. 5 is a flowchart of the process for controlling and adapting the carrier infrastructure and process using formal postal product definition.

FIG. 6 is a flowchart of the mail unit processing in a system controlled by formally defined carrier products.

### DETAILED DESCRIPTION OF THE INVENTION

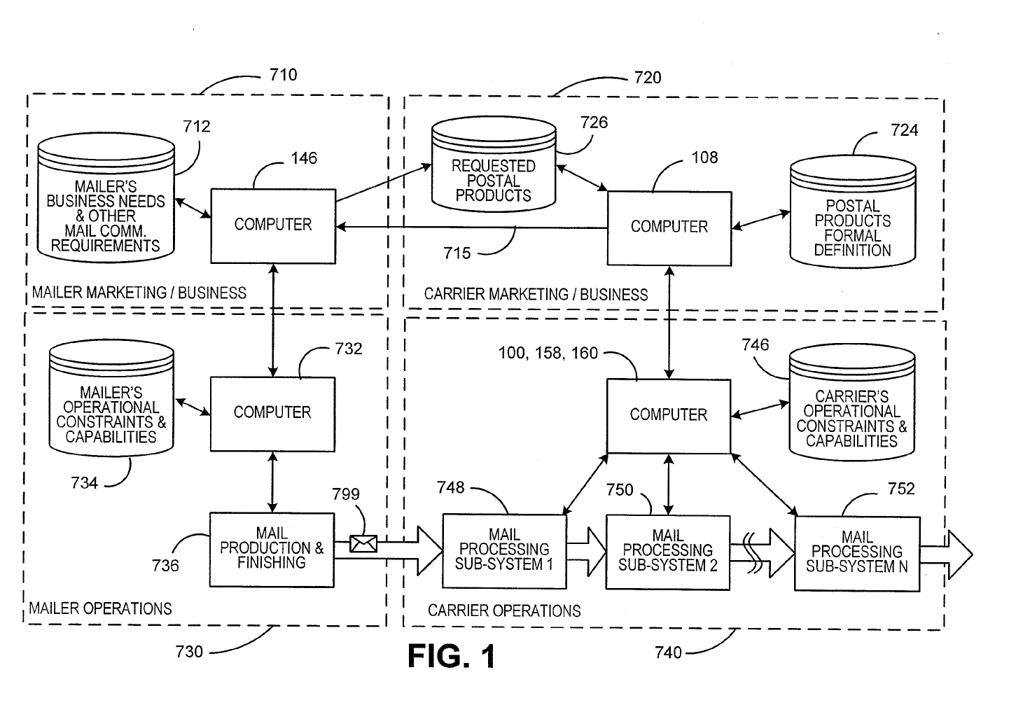

FIG. 1 is a system diagram of the mailer and carrier infrastructure. FIG. 1 generally shows computers, data bases and their connections adopted for this invention. In addition FIG. 1 also schematically shows physical mail creation and processing flow, (generally shown with broad arrows) whereby these processes are controlled by computers operationally connected (generally shown with narrow arrows) to other computers in the information infrastructure. The mailer marketing/business environment includes computer 146 which is coupled to mailer's business needs and other communication requirements data base 712. Data base 712 may include such requirements as tracking information for certain mail items or rules concerning disposition of mail items that can not be delivered due to some missing information.

The mailer's operations 730 includes, computer 732, mailer's operational constraints and capabilities data base 734 and mail production and finishing equipment 736. Computer 732 is coupled to data base 734, and equipment 736. Computer 732 processes the data obtained from computer 146 and contained in data base 734 for the purpose of controlling the mail production and finishing equipment 736. The data processed by computer 732 is essentially driven by a formal description of the postal product obtained from data bases 724 and 726. Data base 734 includes different mailer's operational constraints and capabilities defined in terms of mail items that can be produced by mail production and finishing equipment 736 or various constraints associated with the data that represents the content of mail items to be produced.

The carrier marketing/business environment 720 includes, computer 108, postal products formal definition data base 724 and requested postal products data base 726. Computer 108 is coupled to data base 724 (which contains a complete computer processable definition of postal products) and data base 726 (which contains a data base of postal products being requested by mailers that is modifiable by mailers requests). Computer 108 is also coupled to computer 146 via communications link 715 to enable the transfer of information from computer 108 to computer 146. The transmitted information represents computer processable product definition files.

The carrier operations environment 740 includes, computers 100, 158, and 160. Computers 100, 158, and 160 are operatively connected to carrier's operational constraints and capabilities data base 746, and to mail processing sub-system 748, mail processing sub-system 750 and mail processing sub-system 752. It should be noted that there could be as many mail processing sub-systems as desired. Typically, each sub-system has a distinct functionality. Sub-systems 748, 750 and 752 contain sorters, facer cancellers, transporting equipment and the like. Sub-systems 748, 750 and 752 receive physical mail items that have been processed by mail production and processing equipment 736. Data base 746 contains a computer description of carrier's operational constraints and capabilities, i.e., constraints on dimensions of mail items that can be processed by mail processing sub-systems 748, 750 and 752 or descriptions of areas on the surface of the mail items where information can be captured by said sub-systems. In addition information contained in data base 746 supplies computer 108 via computer 100 with formal descriptions of carrier's operational capabilities to automatically establish operational feasibility of new postal products. The process of computing the operational feasibility is executed by computer 108.

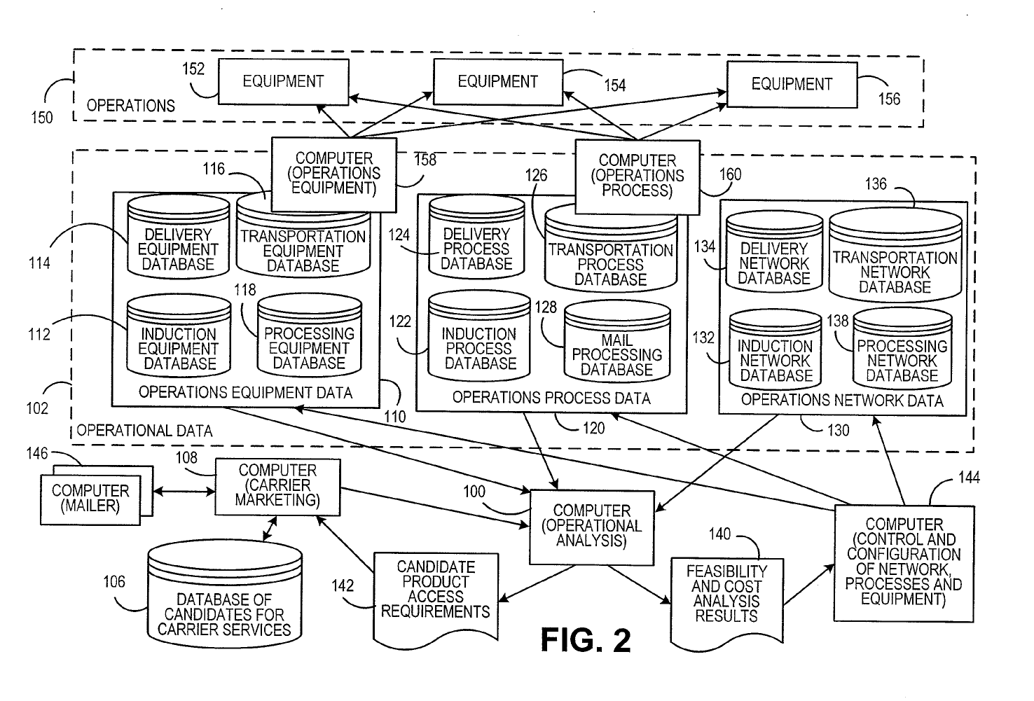

FIG. 2 is a system diagram of the carrier infrastructure. Operational data 102 includes, operations equipment data 110, operations process data 120 and operations network data 130.

Operations equipment data 110 includes induction equipment database 112, delivery equipment database 114, transportation equipment database 116 and processing equipment database 118.

Induction equipment database for example can contain a description of mail makeup verification equipment such as the United States Postal Service MERLIN (Mail Evaluation Readability Lookup Instrument) equipment. MERLIN is the US Postal Service's tool for automating verification of mail at the time of acceptance. MERLIN ensures that the USPS receives quality mail into the processing and distribution system. Such equipment is designed to provide assurances to carriers that mail entering postal network is conformant with postal requirements (see description of element 142 below). Induction equipment database contains description of capabilities of various pieces of induction equipment available to the carrier. Specifically, these capabilities are defined in terms of equipment ability to mechanically process different types of mail units and equipment capabilities of capturing and generating information concerning said mail units. It is also given in terms of limits of its processing capabilities expressed, for example, as number of mail units processed per unit of time. These descriptions are given in terms of attribute names and their allowed values. For example, mail verification system can process mail units constrained by their dimensions from postcards (e.g. 4×6 inches) to large flats (e.g. 20×40 inches). Induction equipment may also be able to capture information present in the top portion of the mail item (for example a strip that is 5 inches high from the upper edge of the mail item).

Delivery equipment database 114 for example can contain carrier sequence barcode sorter that can process #10 envelopes to small flats and capable of capturing information from the bottom strip of mail unit that is one inch high. Another piece of equipment that would be typically employed in delivery operations is a hand-held mail scanner capable of capturing information anywhere on the surface of the mail unit.

Transportation equipment database 116 contains description of mechanical equipment designed to assist human personnel in loading and unloading transportation units such as lorries (trucks), aircraft, railroad cars and alike. Capabilities of this type of equipment are defined by minimum and maximum values for weight and volume of mail units that require loading and unloading.

Processing equipment database 118 contains description of various types of mail processing equipment typically employed at mail processing plants and other similar facilities such as area distribution centers in the United States. The equipment employed in these processing plants consists of cullers, facer cancellers, general mail sorting equipment (OCR based), barcode sorting equipment and various transportation conveyors designed to move containers to and from mail processing equipment. Each basic processing step that is stored in the database 120 is uniquely linked to corresponding pieces of operations equipment stored in database 110. For example, induction process database 122 contains linkages to induction equipment database 112 in such a way that the equipment involved in each step during induction process can be identified and its capabilities can be retrieved from the database 112.

Operation process data 120 contains description of four databases 122, 124, 126 and 128. The description of data contained in these databases is generally given by data structures containing definition of basic elementary steps that are taking place during these processes.

For example, the induction process database 122 contains a description of steps taking place during various induction processes, from unloading street letter boxes into postal collection vehicles to steps taking place during controlled acceptance of large quantities of mail from industrial strength mailers.

For example, the delivery process database 124 contains a description of steps taking place during various delivery processes from final carrier sequence sort to the deposit of mail into the recipient's mail box.

For example, the transportation process database 126 contains a description of steps taking place during various transportation processes such as loading and unloading transportation units, capturing identity of mail containers and physical transportation of containers from their origination to their destination points.

For example, the processing database 128 contains a description of steps taking place during various processing steps such as culling, facing, cancelling and sortation.

Operation network data 130 contains four databases 132, 134, 136 and 138.

For example, the induction network database 132 contains description of locations of all induction facilities available on the network given in terms of postal codes, conventional addresses, geographical coordinates or all of the above. It may also contain processing capacity for facilities positioned at these locations.

For example, the delivery network database 134 contains description of locations of all delivery facilities available on the network given in terms of postal codes, conventional addresses, geographical coordinates or all of the above. It may also contain processing capacity for these locations.

For example, the transportation network database 136 contains description of all pairs of connected origin and destination facilities coupled with timing constraints concerning transportation of mail from originating to destination facilities. These may be given in terms of minimum transit time (given fastest transportation means) and maximum transportation time (slowest transportation means).

For example, the processing network database 138 contains description of processing facilities available on the network given in terms of postal codes, conventional addresses, geographical coordinates or all of the above. It may also contain processing capacity for facilities at these locations.

Operations equipment data 110, operations process data 120 and operations network data 130 also contain relevant cost information associated with equipment, processes and network facilities. These include fixed and variable cost elements.

Database of candidates for carrier services 106 contains XML records descriptive of candidates for postal products. They are created by the marketing department of the carrier based on mailer's and recipients needs and desires and stored in the database 106 as pairs of attribute names and corresponding values or ranges of values.

The following contains detail classification and description of some attributes. The list is not exhaustive and it is open for modification and expansion.

The postal products from the senders prospective contains physical elements. The physical elements of the mail unit are physical parameters “dimensions, volume, density, material characteristics and content”. Content is restricted for certain services for instance you cannot mail liquids or powders. The physical elements also include the geography of induction, geography of delivery of the mail unit, routing information, i.e., the options for selecting a route between induction and delivery points and timing and frequency of collection and delivery of the mail unit.

The informational elements of the postal product from a sender's perspective include the following: sender directed information about events that occurred during the mail unit processing; sender directed information about other mail units that are directly linked to the mail unit that is being served; sender directed information about objects directly linked to the mail unit being served; customer directed information about other mail communications, sent, received or replied by sender and recipient directed information about the mail unit; and customer service provider negotiated information defining remedies for instances when service could not be delivered as specified.

The sender may also specify rules expressing desired conditions imposed on physical and informational elements.

Regarding informational elements the customer may desire to receive information about events (and their corresponding attributes) that occurred during mail unit processing. This information includes information describing significant changes in values of attributes of the mail unit being served, including information concerning such events as deposit, delivery, receipt, impossibility of delivery, mail unit damage or discarding, information concerning defects of the mail unit obtained as a result postal processing including such attributes of mail unit as its digital image or digital image of its content.

The standard of evidence required from a sender's perspective may include defining the information security services for presentation of events information to the sender in both physical and electronic format. Evidence of the data origin authentication, data integrity and privacy may also be required.

The following are other examples of events from a senders perspective: depositing of the mal unit; delivery of the mail unit into recipients mailbox; delivery of the mail unit to the recipient; refusal of the mail unit by the recipient; forwarding of the mail unit to another party; diverting and sending the mail unit to another facility; returning the mail unit to the sender; and destroying the mail unit.

Informational elements customer directed information about other mail units that are directly linked to the mail unit that is being served. Information concerning the whereabouts of reply mail units that is mail items sent by the recipient of the given mail unit as a response to receiving it. Customer directed information about other objects directly linked to the mail unit being served. Information about the structure “building, post office box” identified in the destination address, information about intended or actual recipient of the mail unit.

Informational elements also include customer directed information about other mail communications sent, received or replied to by sender or recipient. Information how many directed mail units has been replied to by the recipient identified in the address block. Recipient directed information about the mail unit include notification about up coming delivery or problems with delivery, and any information valuable to the recipient typically not available to sender at the time of mail unit creation. Customer service provider negotiated information defining remedies when service could not be delivered as specified. Insurance for lost items or refunds for late delivery in similar occurrences and events.

The following is an example of rules from a sender's perspective. If given mail unit cannot be delivered then destroy it and send the digital image of the mail unit back to the sender.

If given mail unit cannot be delivered before this date/time, return mail unit for the sender and credit sender's account. If given mail unit is located in this facility, do not deliver it but send a digital image of the content and identity of the mail unit to this e-mail address. If given mail item unit is located in this facility after this date, send mail unit to different address. If given mail unit weighs less than the given value “e.g. 20 grams,” send a digital image of the mail unit to the sender or notify the sender by electronically sending the mail unit identifier and the value of the attribute named in this instance “weight”.

The carrier marketing computer 108 is adapted for communication of information between database 106 and operational analysis computer 100. Computer 108 is also bi-directionally connected to a multiplicity of mailer's computers generally shown at 146 and controlled by mailers. Computers 146 are adapted to supply information defining mailer's communication needs to computer 108. Computer 108 is similarly adapted to supply postal product information to mailer computers at 146.

The computer 100 is enabled to perform operational analysis based on information received from database 106 via computer 108 and information received from operational databases 102.

Computer 100 outputs feasibility and cost analysis data results stored in a file 140 adapted for communication via computer 144 to operational databases 102. It should be expressly noted that operational data stored in databases 102 can be used for control of the postal network, its processes and equipment. The databases 102 represents network, process and equipment capabilities data that is valid at a given moment of time and at any future moment as defined by the carrier. That means that databases 102 are regularly updated and may contain forward looking capabilities.

Computer 144 is adapted for control and configuration of carrier network, processes and equipment. The data file 142 contains candidate product access requirements for example physical elements, informational elements, rules, and i.e., access requirements. These requirements include the mail unit makeup containing data elements, their format and placement, computerized information to accompany the mailing, its timing, messaging and protocol requirements, grouping and containerization requirements (i.e., presort and packaging rules), pricing and payment requirements, and possibly offering requirements specifying, for example, conditions imposed on the mailer.

Postal operations are shown at 150, and generally consist of various types of equipment such as cullers, facer-cancellers and sorters and processes that enable the flow of mail items in and out of operations. Operations equipment data generally shown at 110 resides at computer 158, which is operationally connected to sorting and other relevant equipment generally shown at 152, 154, and 156. Similarly, operations process data at 120 resides at operations process computer schematically shown at 160 which is also operationally connected to various pieces of equipment 152, 154 and 156.

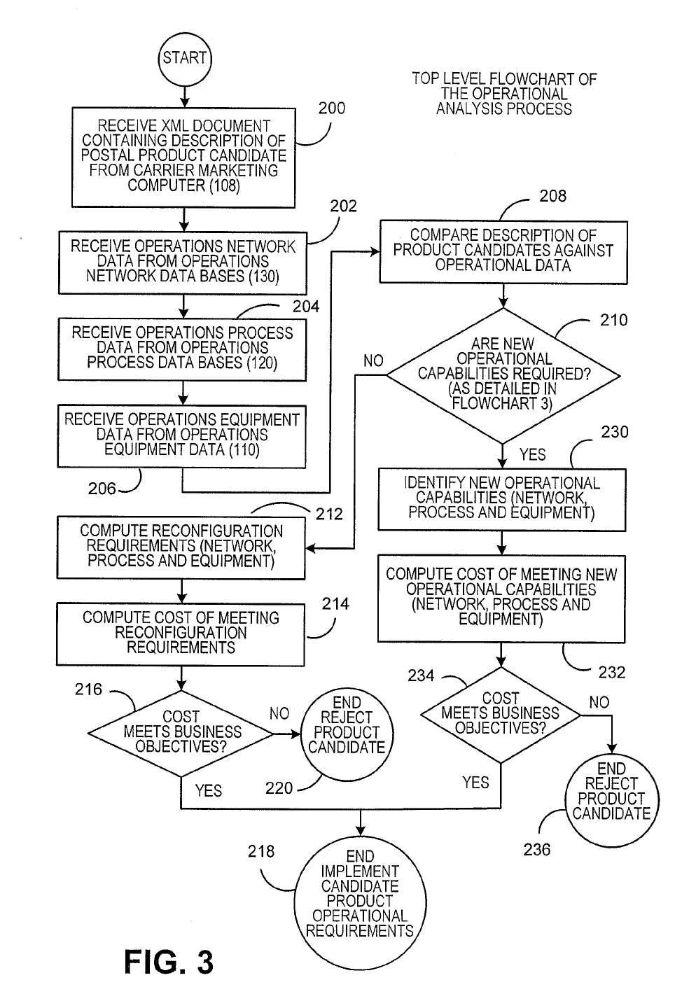

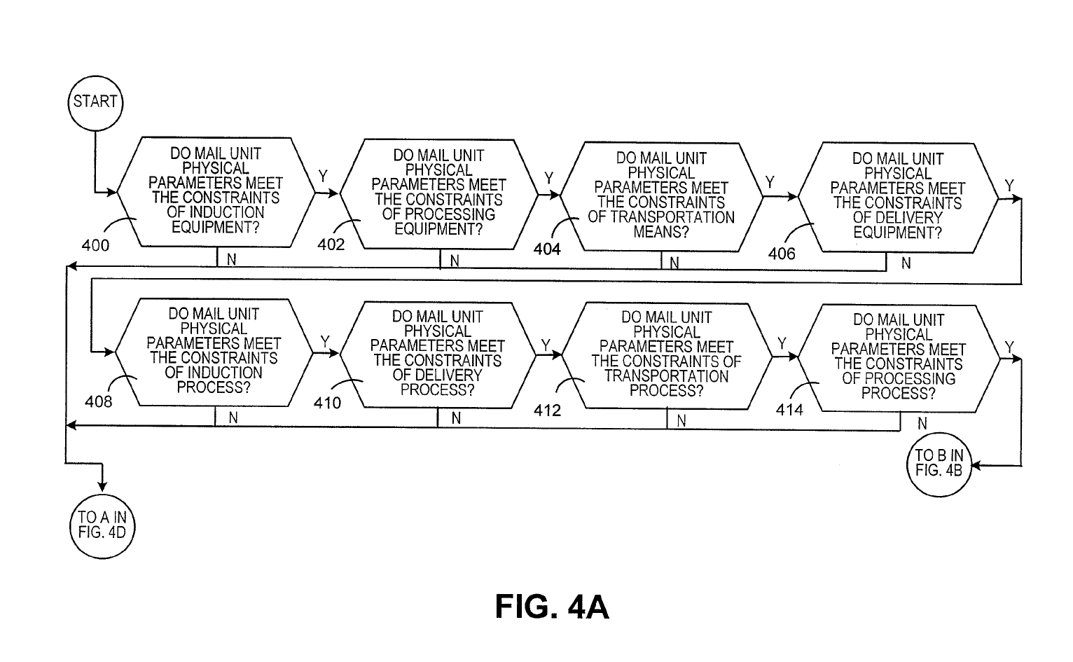

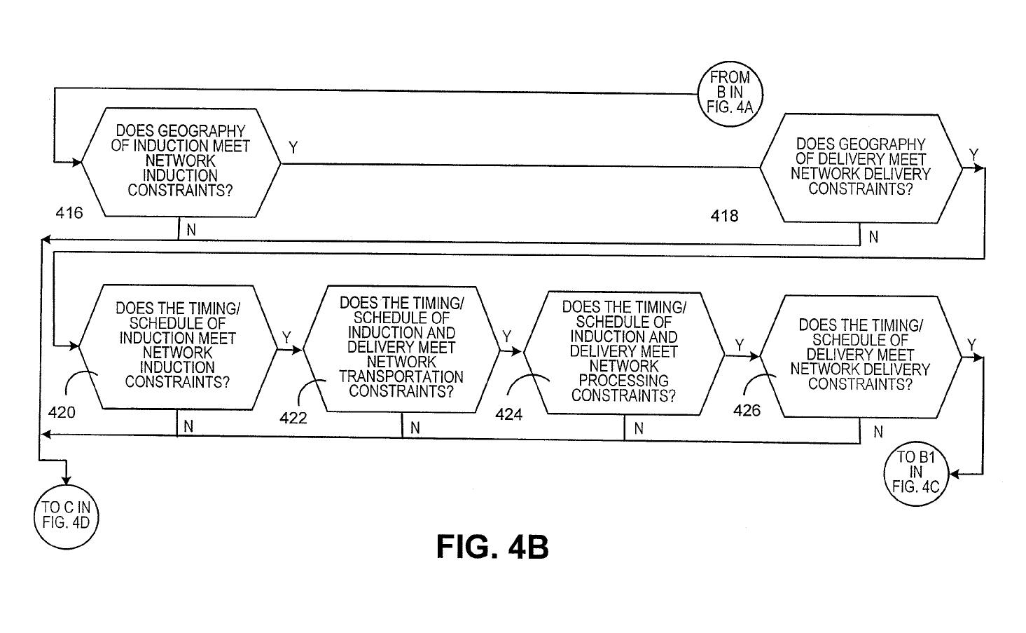

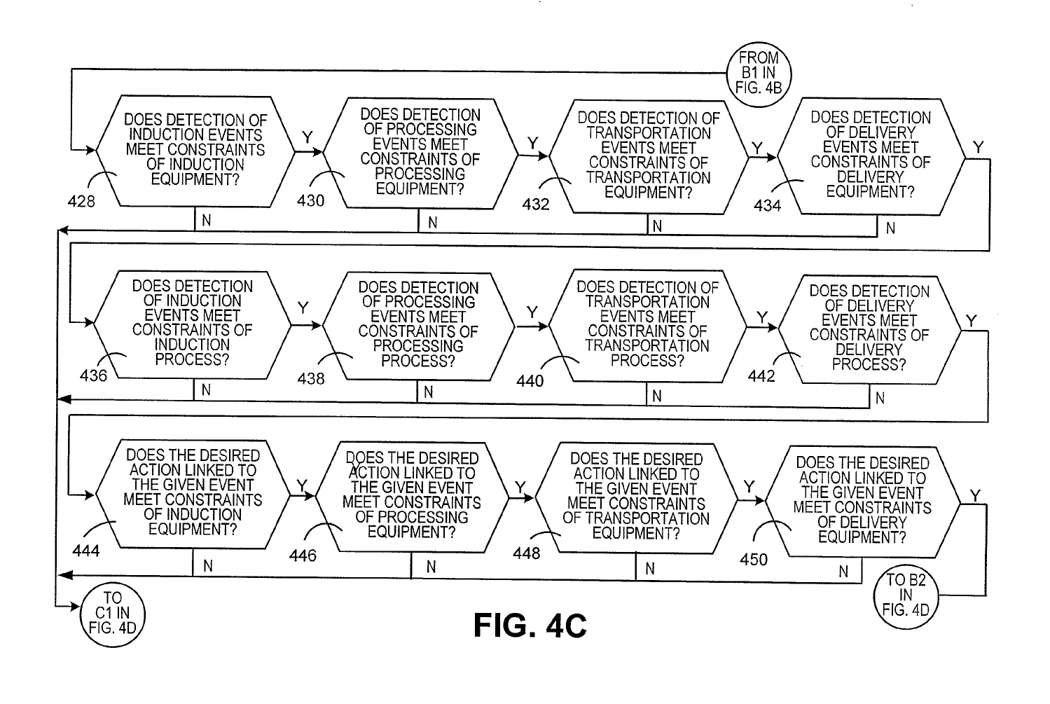

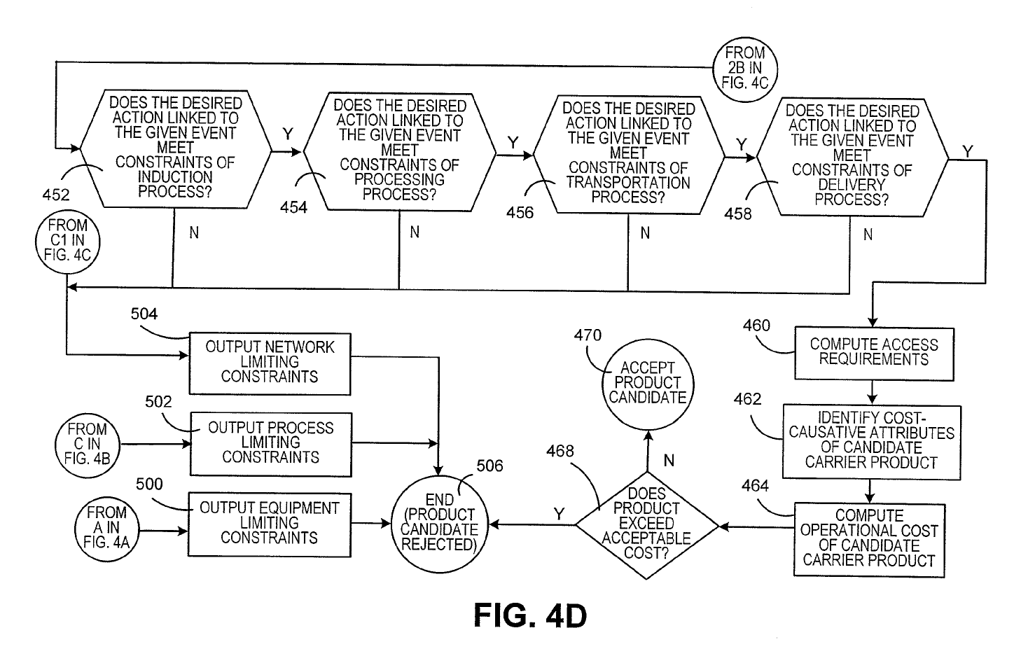

FIG. 3 is the top level flowchart of the operational analysis process. The process begins in block 200 where computer 100 receives an XML document containing descriptions of postal product candidate. This description is obtained from carrier marketing computer 108. Then in block 202 where computer 100 receives operations network data from operations network data bases 130. Now in block 204 computer 100 receives operations process data from operations process data bases 120. Now in block 206 computer 100 receives operations equipment data from operations equipment data bases 110. Then block 208 compares the description of product candidates' against operational data. Next decision block 210 determines whether or not there are new operational capabilities required, which are discussed in the description of FIG. 4.

If no new operational capabilities are required the process goes to block 212. Block 212 computes the reconfiguration requirements for the network, process and equipment. Then the process goes to block 214 to compute the cost of meeting the reconfiguration requirements. Next the process goes to decision block 216. Block 216 determines whether or not the aforementioned cost meets the business objectives? If block 216 determines that said cost does not meet the business objectives the process ends in block 220 where the product candidate is rejected.

If block 210 determines that new operational capabilities are required the process goes to block 230. Block 230 identifies new operational capabilities for the network, process and equipment to accommodate the candidate product. Then the process goes to block 232 to compute the cost of meeting the capabilities for the network, process and equipment. Next the process goes to decision block 234. Block 234 determines whether or not the cost meets the business objectives. If block 234 determines that the cost does not meet the business objectives the process ends in block 236 where the product candidate is rejected.

If decision block 216 or decision block 234 determines that the costs meets the business objectives, the process ends in block 218 where the candidate product operational requirements are implemented.

FIGS. 4A-4D is a flowchart of the process that compares the attributes of the candidate carrier product against the capabilities of the carrier infrastructure to provide a process, network, operational requirements of the new postal product (operational feasibility). FIGS. 4A-4D is structured with regard to the types of processing equipment, operational process, and network data, involved in the overall cycle of mail delivery.

FIGS. 4A-4D are constructed around analysis of three different categories of constraints. The first category includes blocks 400, 402, 404, 406, 408, 410, 412 and 414 (FIG. 4A) consists of decision points regarding physical processability of mail units. The second category consisting of blocks 416, 418, 420, 422, 424 and 426 (FIG. 4B) includes decision points concerning carrier network constraints such as ability of the carrier to accept a given mail unit at different induction points or deliver mail units at delivery points. The third category consisting of blocks 428-458 (FIGS. 4C and 4D) and includes decision points concerning various aspects of carrier process such as detection of events during induction, sortation and delivery. In addition there are also decision points concerning actions that could be taken by the carrier in response to the aforementioned events. The outcome of the decision points (branching of the decision block into “yes” or “no” decisions) is linked to several output conditions for the entire process. These are shown at output conditions blocks 460, 462, and 464 for “yes” branches and blocks 500, 502 and 504 for the “no” branches. The overall process ends either at block 506 where an updated product is rejected or block 470 where the candidate product is accepted.

Decision block 400 (FIG. 4A) determines whether or not the mail unit physical parameters meet the constraints of mail induction equipment. If decision block 400 determines that the mail unit physical parameters do not meet the constraints of mail induction equipment the process branches to block 500. Block 500 outputs details of the limiting constraints of the induction equipment denied by block 400. An example of an output limiting constraint is that the equipment can not process mail items having a length greater than 15 inches. If decision block 400 determines that the mail unit physical parameters do meet the constraints of mail induction equipment the process goes to decision block 402.

Decision block 402 determines whether or not the mail unit physical parameters meet the constraints of mail processing equipment. If decision block 402 determines that the mail unit physical parameters do not meet the constraints of the processing equipment the process branches to block 500. Block 500 outputs details of the limiting equipment constraints of the processing equipment denied by block 402. If decision block 402 determines that the mail unit physical parameters meet the constraints of processing equipment the process goes to decision block 404.

Decision block 404 determines whether or not the mail unit physical parameters meet the constraints of mail transportation means. If block 404 determines that the mail unit physical parameters do not meet the constraints of mail transportation means the process branches to block 500. Block 500 outputs details of the limiting equipment constraints of the transportation means denied by block 404. If block 404 determines that the mail unit physical parameters meet the constraints of mail transportation means the process goes to block 406.

Decision block 406 determines whether or not the mail unit physical parameters meet the constraints of mail delivery equipment. If block 406 determines that the mail unit physical parameters do not meet the constraints of mail delivery equipment the process branches to block 500. Block 500 outputs details of the limiting equipment constraints of the delivery equipment denied by block 406. If block 406 determines that the mail unit physical parameters meet the constraints of mail delivery equipment the process goes to block 408.

Decision block 408 determines whether or not the mail unit physical parameters meet the constraints of the mail induction process. If block 408 determines that the mail unit physical parameters do not meet the constraints of the mail induction process the process branches to block 500. Block 500 outputs details of the limiting equipment constraints of the induction process denied by block 408. If block 408 determines that the mail unit physical parameters meet the constraints of the mail induction process the process goes to block 410.

Decision block 410 determines whether or not the mail unit physical parameters meet the constraints of the mail delivery process. If block 410 determines that the mail unit physical parameters do not meet the constraints of mail delivery process the process branches to block 500. Block 500 outputs details of the limiting equipment constraints of the delivery process denied by block 410. If block 410 determines that the mail unit physical parameters meet the constraints of mail delivery process the process goes to block 412.

Decision block 412 determines whether or not the mail unit physical parameters meet the constraints of the transportation process. If block 412 determines that the mail unit physical parameters do not meet the constraints of the transportation process the process branches to block 500. Block 500 outputs details of the limiting equipment constraints of the transportation process denied by block 412. If block 412 determines that the mail unit physical parameters meet the constraints of the transportation process the process goes to decision block 414.

Decision block 414 determines whether or not the mail unit physical parameters meet the constraints of the processing (e.g. sortation) process. If block 414 determines that the mail unit physical parameters do not meet the constraints of the mail processing process the process branches to block 500. Block 502 outputs details of the limiting process constraints of the processing process denied by block 414. If block 414 determines that the mail unit physical parameters meet the constraints of the processing process the process the process goes to decision block 416 (FIG. 4B).

Decision block 416 determines whether or not the geography of the induction required by the new product meets the network induction constraints. If block 416 determines that the geography of the induction do not meet the network induction constraints the process branches to block 502. Block 502 outputs details of the limiting process constraints of the network induction constraints denied by block 416. An example of output process limiting constraints is that the equipment can not process more than 5,000 mail items an hour. If block 416 determines that the induction meets the constraints of the induction process the process goes to decision block 418.

Decision block 418 determines whether or not the geography of delivery meets the network delivery constraints. If block 418 determines that the geography of delivery does not meet the network delivery constraints the process branches to block 502. Next block 502 outputs details of the limiting network constraints of the geography of delivery network denied by block 418. If block 418 determines that the geography of delivery meets the network delivery constraints the process goes to decision block 420.

Decision block 420 determines whether or not the timing/schedule of induction meets the network induction constraints. If block 420 determines that the timing/schedule of induction does not meet the network induction constraints the process branches to block 502. Then block 502 outputs details of the timing/schedule of induction limiting process constraints denied by block 420. If block 420 determines that the timing/schedule of induction meets the network induction constraints the process goes to decision block 422.

Decision block 422 determines whether or not the timing schedule of induction and delivery meets the network transportation constraints. If block 422 determines that the timing schedule of induction and delivery does not meet the network transportation constraints the process branches to block 502. Then block 502 outputs details of the timing/schedule of induction and delivery limiting process constraints denied by block 422. If block 422 determines that the timing/schedule of induction and delivery meets the network transportation constraints the process goes to decision block 424.

Decision block 424 determines whether or not the timing/schedule of induction and delivery meets the network processing constraints. If block 424 determines that the timing/schedule of induction and delivery does not meet the network processing constraints the process branches to block 502. Then block 502 outputs details of the timing/schedule of induction and delivery network processing limiting process constraints denied by block 424. If block 424 determines that the timing/schedule of induction and delivery meets the network processing constraints the process goes to decision block 426.

Decision block 426 determines whether or not the timing/schedule of delivery meets the network delivery constraints. If block 426 determines that the timing/schedule of delivery does not meet the network delivery constraints the process branches to block 502. Then block 502 outputs details of the timing/schedule of delivery network processing limiting process constraints denied by block 426. If block 426 determines that the timing/schedule of delivery meets the network processing constraints the process goes to decision block 428 (FIG. 4C).

Decision block 428 determines whether or not the detection of induction events meets the constraints of induction equipment. If block 428 determines that the details of the detection of induction events do not meet the constraints of induction equipment the process branches to block 504. Next block 504 outputs details of the network limiting constraints of induction equipment denied by block 428 and the feasibility of the postal product being analyzed. An example of an network limiting constraint is that the mail item has a non-existing address for the purpose of the postal network, or the mail item can not be inducted at the location the mailer wants to induct the mail item. If block 428 determines that the detection of induction events meets the constraints of induction equipment the process goes to decision block 430.

Decision block 430 determines whether or not the detection of processing events meets the constraints of processing equipment. If block 430 determines that the details of the detection of processing events do not meet the constraints of processing equipment the process branches to block 504. Next block 504 outputs details of the network limiting constraints of processing equipment denied by block 430. If block 430 determines that the detection of processing events meets the constraints of processing equipment the process goes to decision block 432.

Decision block 432 determines whether or not the detection of transportation events meets the constraints of transportation equipment. If block 432 determines that the details of the detection of transportation events do not meet the constraints of transportation equipment the process branches to block 504. Next block 504 outputs details of the network limiting constraints of transportation equipment denied by block 432. If block 432 determines that the detection of transportation events meets the constraints of transportation equipment the process goes to decision block 434.

Decision block 434 determines whether or not the detection of delivery events meets the constraints of delivery equipment. If block 434 determines that the details of the detection of delivery events do not meet the constraints of delivery equipment the process branches to block 504. Next block 504 outputs details of the detection of delivery events limiting network constraints of delivery equipment denied by block 434. If block 434 determines that the detection of delivery events meets the constraints of delivery equipment the process goes to decision block 436.

Decision block 436 determines whether or not the detection of induction events meets the constraints of the induction process. If block 436 determines that the details of the detection of induction events do not meet the constraints of the induction process the process branches to block 504. Next block 504 outputs details of the detection of induction events limiting network constraints of the induction process denied by block 436. If block 436 determines that the detection of induction events meets the constraints of the induction process the process goes to decision block 438.

Decision block 438 determines whether or not the detection of processing events meets the constraints of the processing process. If block 438 determines that the details of the processing events do not meet the constraints of the processing process the process branches to block 504. Next block 504 outputs details of the network limiting constraints of the processing process denied by block 438. If block 438 determines that the detection of processing events meets the constraints of the processing process the process goes to decision block 440.

Decision block 440 determines whether or not the detection of transportation events meets the constraints of the transportation process. If block 440 determines that the detection of the transportation events do not meet the constraints of the transportation process the process branches to block 504. Next block 504 outputs details of the limiting network constraints of the transportation process denied by block 440. If block 440 determines that the detection of transportation events meets the constraints of the transportation process the process goes to decision block 442.

Decision block 442 determines whether or not the detection of delivery events meets the constraints of the delivery process. If block 442 determines that the details of the delivery events do not meet the constraints of the delivery process the process branches to block 504. Next block 504 outputs details of the limiting network constraints of the delivery process denied by block 442. If block 442 determines that the detection of delivery events meets the constraints of the delivery process the process goes to decision block 444.

Decision block 444 determines whether or not the desired action linked to the given event meets the constraints of the induction equipment. If block 444 determines that the desired action linked to the given event does not meet the constraints of the induction the process branches to block 504. Next block 504 outputs details of the network limiting constraints denied by block 444. If block 444 determines the desired action linked to the given event meets the constraints of the induction equipment the process goes to decision block 446.

Decision block 446 determines whether or not the desired action linked to the given event meets the constraints of the processing equipment. If block 446 determines that the desired action linked to the given event does not meet the constraints of the processing equipment the process branches to block 504. Next block 504 outputs details of the output network limiting constraints denied by block 446. If block 446 determines the desired action linked to the given event meets the constraints of the processing equipment the process goes to decision block 448.

Decision block 448 determines whether or not the desired action linked to the given event meets the constraints of the transportation equipment. If block 448 determines that the desired action linked to the given event does not meet the constraints of the transportation equipment the process branches to block 504. Next block 504 outputs details of the network limiting constraints denied by block 448. If block 448 determines the desired action linked to the given event meets the constraints of the transportation equipment the process goes to decision block 450.

Decision block 450 determines whether or not the desired action linked to the given event meets the constraints of the delivery equipment. If block 450 determines that the desired action linked to the given event does not meet the constraints of the delivery equipment the process branches to block 504. Next block 504 outputs details of the network limiting constraints denied by block 450. If block 450 determines the desired action linked to the given event meets the constraints of the delivery equipment the process goes to decision block 452 (FIG. 4D).

Decision block 452 determines whether or not the desired action linked to the given event meets the constraints of the induction process. If block 452 determines that the desired action linked to the given event does not meet the constraints of the induction process the process branches to block 504. Next block 504 outputs details of the network limiting constraints denied by block 452. If block 452 determines the desired action linked to the given event meets the constraints of the induction process the process goes to decision block 454.

Decision block 454 determines whether or not the desired action linked to the given event meets the constraints of the processing process. If block 454 determines that the desired action linked to the given event does not meet the constraints of the processing process the process branches to block 504. Next block 504 outputs details of the network limiting constraints denied by block 454. If block 454 determines the desired action linked to the given event meets the constraints of the processing process the process goes to decision block 456.

Decision block 456 determines whether or not the desired action linked to the given event meets the constraints of the transportation process. If block 456 determines that the desired action linked to the given event does not meet the constraints of the transportation process the process branches to block 504. Next block 504 outputs details of the network limiting constraints denied by block 456. If block 456 determines the desired action linked to the given event meets the constraints of the processing process the process goes to decision block 458.

Decision block 458 determines whether or not the desired action linked to the given event meets the constraints of the delivery process. If block 458 determines that the desired action linked to the given event does not meet the constraints of the delivery process the process branches to block 504. Next block 504 outputs details of the network limiting constraints denied by block 458. If block 458 determines the desired action linked to the given event meets the constraints of the delivery process the process goes to block 460.

The outputs of blocks 500, 502 and 504 goes to 506 where the product candidate is rejected.

Block 460 computes the access requirements necessary to meet network, process and equipment constraints associated with the delivery of the new product. Access requirements for a given product typically may contain several elements for example the content of the mail unit may be restricted to exclude liquids, perishable goods, explosives, armaments, medicines and the like. Information that is present on the mail unit may be restricted as to its contents, format and placement. For example, a given product may require that the mailer prints a destination address block in the bottom lower portion of the envelope, and the address information must be verified against carrier-approved addressing data bases and the printing font and line spacing are restricted to a specific set of choices. In addition the mail unit access requirements may include printing of various machine readable elements such as identifiers for the mail unit itself, the product, postage evidencing, endorsements, slogans, and the like. Another element of product access requirement may include a demand by the carrier that the mailer should supply certain information above and beyond information that is supplied by the mailer using the mail unit itself. This includes electronic information concerning a set of mail units supplied in a single submission into the carrier distribution network. For example, electronic or physical documents known as manifests and statements of mailing submission belong to this category of access requirements.

It should be noted that the aforementioned set of mail units can consist of any number of members beginning with one member only. Yet another access requirement element is containerization and presort requirements, imposed by the carrier when the aforementioned set of mail units consist of at least several members, typically 200 or more. In this case a mailer is required to place mail units in a certain order and containerize the mail unit into carrier approved receptacles such as trays, sacks, pallets and the like. The carrier may also require that said receptacles should be labeled with information elements containing descriptions of the contents of the receptacles. In this case the data content, format and placement for the labels also form a part of the access requirements. In addition access requirements include pricing and payment information specifying how much, to whom and when the payment for the product should be made.

It should be expressly noted that a carrier can impose any other conditions on the mailer desiring to buy a given product. For example, a carrier may restrict access to the given product to mailers from certain geographic areas, or allow the product to be purchased only during given periods of time or by mailers that have certain long standing trusted relations to the carrier. Generally the carrier can use any attribute in the formal description of the product to restrict access to this product for customers (senders and recipients).

Then block 462 identifies which attribute of the postal product influences the cost of producing the postal product. Next block 464 calculates the operational cost of the candidate carrier product. At this point the process goes to decision block 468. Decision block 468 determines whether or not the candidate postal product exceeds acceptable cost. If block 468 determines that the candidate postal product exceeds acceptable cost the process goes to 506 where it ends. If block 468 determines that the candidate postal product does not exceed acceptable cost the process goes to 470 to accept the product candidate and also end the process.

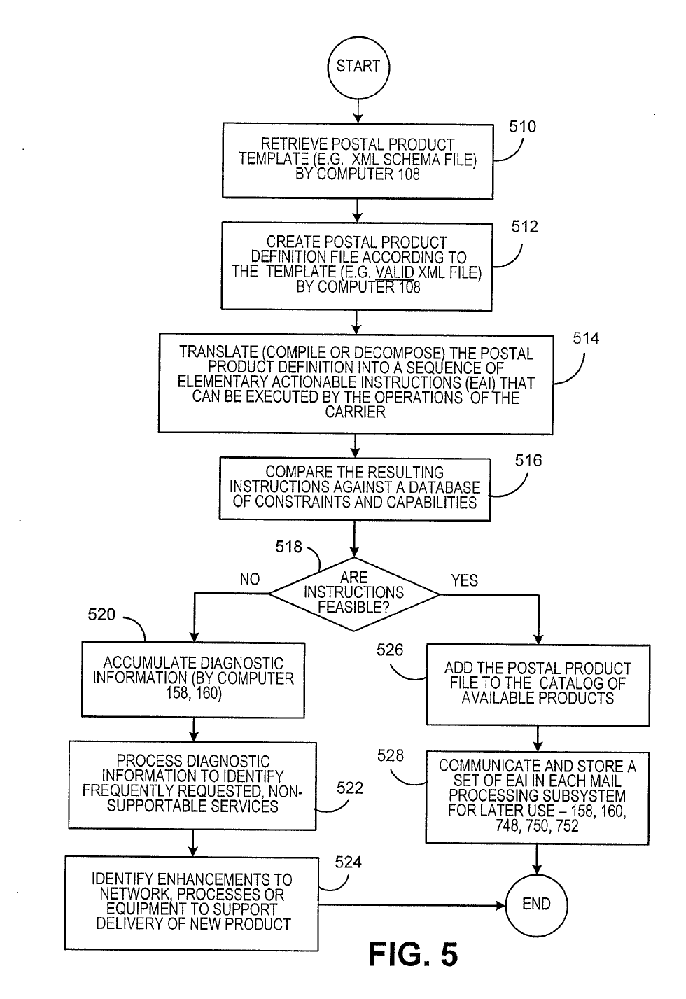

FIG. 5 is a flowchart of the process for controlling and adapting the carrier infrastructure and process using formal postal product definition. After starting the postal product template e.g. the XML schema file is retrieved at block 510 by computer 108 (FIG. 2). The process continues to block 512 where computer 108 creates a carrier product definition file (e.g. valid XML) according to the template (XML schema file). Then block 514 translates (compiles or decomposes) the postal product definition file into a sequence of elementary actionable instructions (EAI) that can be executed by the operations of the carrier by utilizing computers 158 and 160 (FIG. 2). Now block 516 compares the resulting instructions against a data base of constraints and capabilities obtained from the process depicted in FIG. 4D specifically blocks 500, 502 and 504 that output various constraints. Then the process goes to decision block 518. Block 518 determines whether or not the instructions are feasible. If block 518 determines that the instructions are not feasible the process goes to block 520.

Block 520 accumulates diagnostic information by computers 158 and 160. Then block 522 utilizes process diagnostic information to identify frequently requested non-supportable services. Next block 524 Identifies enhancements to network, processes or equipment required to support delivery of a new product that ends this branch of the flow chart.

If block 518 determines that the instructions are feasible the process goes to block 526. In block 526 the postal product definition file is added to the catalog of available products by computer 108 (FIG. 2) and data base 724 (FIG. 1). The process continues to block 528 where a set of EAI is communicated and stored in computers 158 and 160 for use with mail processing sub-systems (748, 750 and 752). That ends this branch of the process.

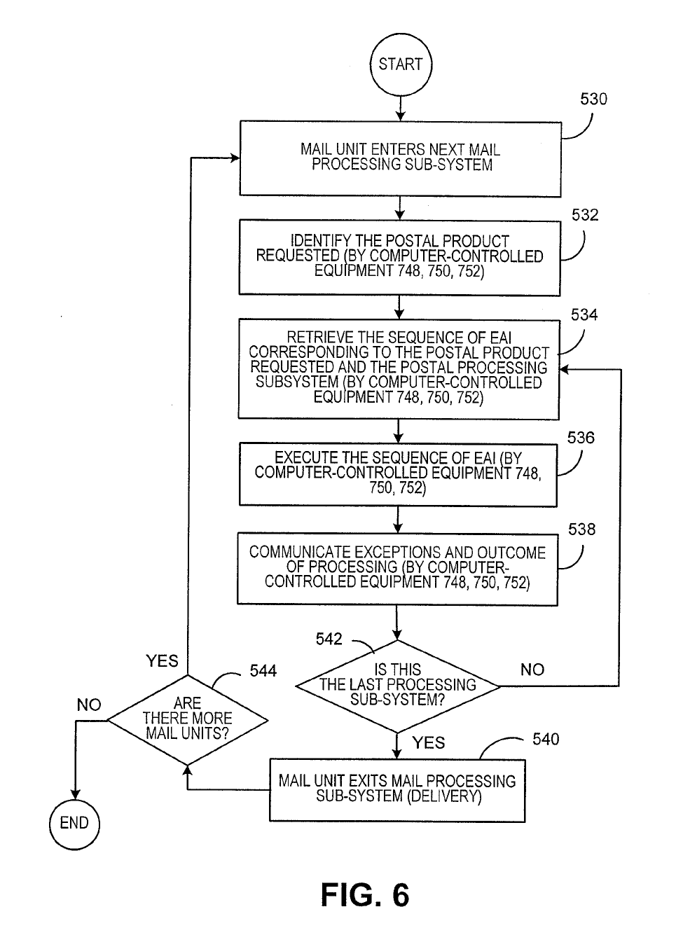

FIG. 6 is a flowchart of the mail unit processing in a system controlled by formally defined carrier products. Starting in block 530 the mail unit enters the first mail processing sub-system. Mail processing sub-systems 1 through N (generally shown in FIG. 1 at 748, 750 and 752) are controlled by a multitude of computer systems shown in the same FIG. 1 at 100, 158 and 160. The process continues to block 532 where information identifying the postal product is captured from a mail unit. It should be noted that the information identifying the postal product may be fully represented on the mail unit itself or alternatively it can be partially represented whereby the remainder of the information is referenced from additional (electronic) information resources. Now at block 534 sub-systems 748, 750 and 752 retrieve the sequence of EAI corresponding to the postal product identified at 532. Next at block 536 sub-systems 748, 750 and 752 execute the sequence of EAI by mail processing sub-system 748, 750 or 752 controlled by computers 100, 158 or 160. Next at block 538 sub-systems 748, 750 and 752 output information obtained as a result of processing of the mail unit including possible exceptional and error conditions. The output of the information in this case also means communication of the information to all interested parties including carrier's customers.

Then at block 542 the determination is made whether the processing sub-system that executed the sequence of EAI is the last processing sub-system of the carrier processing sub-systems for the mail unit that entered this processing at block 530. If there are more processing sub-systems to operate on the mail unit the process branches to block 534 until the last processing sub-system has been reached. At this point the process moves into block 540 where the mail unit exits carrier processing, typically after its delivery to the recipient. If there are no more mail units to be processed which is determined at block 544, the process reverts to block 530. Otherwise the process ends after all mail units have been processed by all mail processing sub-systems.

The above specification describes a new and improved method for creating new carrier products under control of a computer. It is realized that the above description may indicate to those skilled in the art additional ways in which the principles of this invention may be used without departing from the spirit. Therefore, it is intended that this invention be limited only by the scope of the appended claims.

What is claimed is:

1. Method for creating new carrier products under control of a computer, said method comprises the steps of:
A. obtaining by the computer a formal description of a candidate for a carrier product containing a set of attributes and their values;
B. obtaining by the computer a formal description of actual carrier network, process and equipment capabilities and constraints expressed as a set of attributes and their values;
C. creating by the computer a comparison between carrier network, process and equipment capabilities contained in the description of a candidate carrier product and the actual carrier network, process and equipment capabilities and constraints;
D. determining feasibility of the candidate carrier product based upon the comparison made in step C; and
E. identifying modifications required for delivery of the candidate product in terms of modifications to network, process and equipment.

2. The method claimed in claim 1, further including the step of:
determining cost of modifications using cost-causative attributes of the carrier network, process and equipment.

3. The method claimed in claim 1, further including the step of:
determining the viability of candidate carrier product based on the cost of required modifications.

4. The method claimed in claim 1, wherein the formal description of the candidate for a carrier product, further includes mail user's requirements.

5. The method claimed in claim 1, wherein the modifications are made when the candidate carrier product is determined to be not feasible.

6. The method claimed in claim 5, wherein the modifications are based upon capabilities of the carrier network, process and equipment.

7. The method claimed in claim 1, further including the step of:
computing access requirements for the candidate carrier product that must be satisfied by information on a mail unit.

8. The method claimed in claim 7, further including the step of:
computing access requirements for the candidate carrier product that must be satisfied by information provided by a mailer.

9. The method claimed in claim 7, wherein the access requirements include content restrictions.

10. The method claimed in claim 9, wherein the content restrictions include: address block format, data quality and data placement.

11. The method claimed in claim 9, wherein the content restrictions include: destination address block format, data quality and data placement.

12. The method claimed in claim 7, wherein the access requirements include postage evidencing block format, data quality and data placement.

13. The method claimed in claim 7, wherein the access requirements include endorsement block, product, identifiers and slogans.

14. The method claimed in claim 7, wherein the access requirements include; pricing, payment and credit requirements.

15. The method claimed in claim 14, further including timing of payment and its value.

16. The method claimed in claim 1, further including the step of:
computing access requirements for the candidate carrier product including containerization requirements for a plurality of the mail units.

17. The method claimed in claim 1, further including the step of:
computing access requirements for the candidate carrier product including presort requirements for a plurality of the mail units.

18. A method for defining instructions executable by carrier processing equipment obtained from formal definition of a carrier product said method comprises the steps of:
A. obtaining formal description of carrier product;
B. decomposing carrier product description into attributes and their values corresponding to elementary processing steps of the carrier operations; and
C. translating the postal product description into a sequence of elementary actionable instructions (EAI) executable by the carrier operations.

19. The method claimed in claim 18, further including the steps of:
determining which of the EAI result from attributes of the candidate carrier product which are cost causative; and
computing operational cost of the candidate carrier product using cost causative attributes.
